(19) United States
(12) Patent Application Publication
(10) Pub. No.: US 2026/0186891 A1
(43) Pub. Date: Jul. 2, 2026

(54) DYNAMIC ERROR CORRECTION SCHEMES FOR MEMORY SYSTEMS

(71) Applicant: Micron Technology, Inc., Boise, ID (US)

(72) Inventors: Anthony D. Veches, Boise, ID (US); Frank F. Ross, Boise, ID (US); Scott E. Schaefer, Boise, ID (US); Sujeet V. Ayyapureddi, Boise, ID (US); Randall J. Rooney, Boise, ID (US); Navid Lashkarian, Pleasanton, CA (US); Matthew A. Prather, Boise, ID (US)

(21) Appl. No.: 19/420,416

(22) Filed: Dec. 15, 2025

Related U.S. Application Data
(60) Provisional application No. 63/740,083, filed on Dec. 30, 2024.

(51) Int. Cl. G06F 11/07

(52) U.S. Cl. CPC G06F 11/0793; G06F 11/073

(57) ABSTRACT

Methods, systems, and devices for dynamic error correction schemes for memory systems are described. A memory system may include an error control component and one or more memory devices coupled with the error control component. The memory system may be configured to detect one or more trigger conditions for adjusting an error control operation of a memory system. The memory system may select an error control scheme from a plurality of error control schemes that are implemented by the error control component based on detecting the one or more trigger conditions. The error control component of the memory system may use the selected error control scheme to perform one or more error control operations to protect data stored at the one or more memory devices.

### CROSS REFERENCE

The present Application for Patent claims priority to U.S. Patent Application No. 63/740,083 by Veches et al., entitled “DYNAMIC ERROR CORRECTION SCHEMES FOR MEMORY SYSTEMS,” filed Dec. 30, 2024, which is assigned to the assignee hereof, and which is expressly incorporated by reference in its entirety herein.

### TECHNICAL FIELD

The following relates to one or more systems for memory, including dynamic error correction schemes for memory systems.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports dynamic error correction schemes for memory systems in accordance with examples as disclosed herein.

FIG. 2 shows an example of a system that supports dynamic error correction schemes for memory systems in accordance with examples as disclosed herein.

FIG. 3 shows an example of a process flow that supports dynamic error correction schemes for memory systems in accordance with examples as disclosed herein.

FIG. 4 shows a block diagram of a memory system that supports dynamic error correction schemes for memory systems in accordance with examples as disclosed herein.

FIG. 5 shows a flowchart illustrating a method or methods that support dynamic error correction schemes for memory systems in accordance with examples as disclosed herein.

### DETAILED DESCRIPTION

A memory system may support error control techniques (e.g., such as on-die error correcting code (ECC), on-die error detecting code (EDC), or other schemes) to improve data integrity (e.g., by detecting and/or correcting data bit errors). For instance, such techniques may mitigate data corruption, data loss, and other adverse effects at the memory system. Some memory systems may implement a relatively static error control technique in which the error control methods (e.g., detection and correction) may be predefined and/or unchangeable once implemented at the memory system (e.g., thus providing a fixed level of error protection). However, such static error control implementations may not have an ability to adapt to varying operating conditions. For instance, error characteristics (e.g., error rates, based on system health and/or hardware integrity), operational environments (e.g., such as fluctuations in temperature or changes in workload), and host expectations (e.g., requesting different levels of error protection) may change over time (e.g., as the memory system ages), and static error control techniques may be unable to adapt to such changes. Alternatively or additionally, different users of memory systems may have different requirements for error control. However, a memory system may have a single error control approach for any user of a memory system. Thus, some memory systems may lack an ability to dynamically adapt (e.g., change, update, modify) an error control scheme, which may lead to relatively higher error rates, data loss, and other effects that reduce the reliability and efficiency of the memory system.

In accordance with one or more techniques described herein, a memory system may support dynamic adaptation of error control schemes. For example, a memory system may be enabled to detect (e.g., sense, determine, identify, monitor) one or more error control trigger conditions, such as error rates (e.g., a threshold quantity of errors), system health metrics, threshold durations (e.g., associated with system lifetime), thermal metrics, host signaling, performance metrics, and other conditions. Additionally, in some examples, a memory system may include an error control component (e.g., a buffer, coupled with one or more memory array dies of the system), which may be capable of supporting a variety of error control schemes. Thus, based on detecting the error control trigger conditions, the memory system may select an error control scheme from a set of multiple schemes supported by the error control component and may perform one or more error control operations using the selected scheme. Accordingly, the memory system may be enabled to dynamically adapt (e.g., change) error control operations, which may result in improved robustness of data integrity management, extended operational life of the memory system, and improved efficiency in diverse and changing environments, among other benefits. Additionally, or alternatively, the memory system may be enabled to select error control operations at an initialization of the memory system based on various inputs.

In addition to applicability in memory systems as described herein, techniques for dynamic error correction schemes for memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving data reliability, which may decrease processing or latency times, improve response times, or otherwise improve user experience, among other benefits.

Features of the disclosure are illustrated and described in the context of systems and architectures. Features of the disclosure are further illustrated and described in the context of process flows and flowcharts.

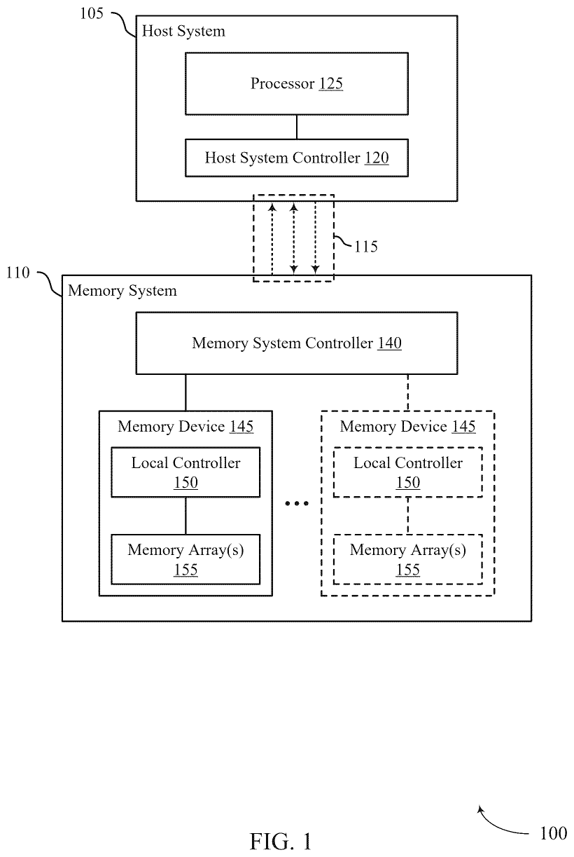

FIG. 1 illustrates an example of a system 100 that supports dynamic error correction schemes for memory systems in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

In some cases, the memory system 110 may support error control techniques (e.g., such as ECC schemes) to improve data integrity. However, some error control implementations may not have an ability to adapt to varying operating conditions (e.g., may be static, predefined, and/or unmodifiable during operation). For instance, error characteristics (e.g., error rates), operational environments (e.g., temperature fluctuations), and host interface expectations may change over time (e.g., as the memory system 110 ages), and some error control techniques may be unable to adapt to such changes, leading to relatively higher error rates, data loss, and other effects that reduce the reliability and efficiency of the system 100.

In accordance with one or more techniques described herein, a memory system 110 (e.g., and/or a host system 105) may support dynamic adaptation of error control schemes. For example, the memory system 110 may be enabled to detect (e.g., sense, determine, identify, monitor) one or more error control trigger conditions, such as error rates, system health metrics, threshold durations, thermal metrics, signaling from the host system 105, performance metrics, and other conditions. The memory system 110, in some examples, may include an error control component (e.g., that is separate from the memory system controller 140 and the memory devices 145, a buffer), which may be capable of supporting multiple error control schemes. Accordingly, based on detecting the error control trigger conditions, the memory system 110 may select an error control scheme from the multiple supported schemes and perform an error control operation using the selected scheme. Thus, the system 100 may support dynamic adaptability for error control operations, resulting in improved data integrity management, extended operational life of the system 100, and improved efficiency in various operating conditions.

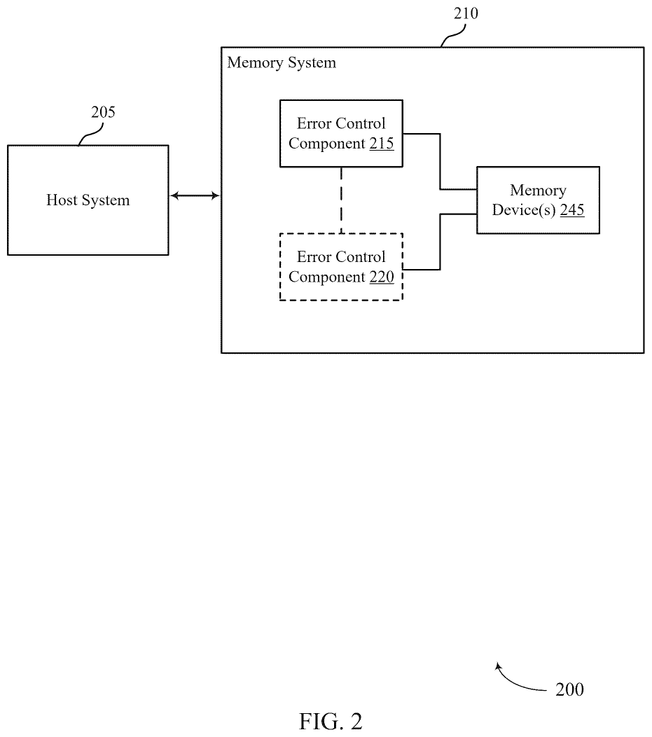

FIG. 2 shows an example of a system 200 that supports dynamic error correction schemes for memory systems in accordance with examples as disclosed herein. The system 200 may include components that are examples of, or include, other components described herein, including with reference to FIG. 1. For example, the system 200 may include a host system 205, a memory system 210, and one or more memory devices 245, which may be examples of a host system 105, a memory system 110, and memory devices 145 respectively. The memory system 210 may include (e.g., in addition to other components not shown, such as a memory system controller 140) one or more error control components (e.g., an error control component 215 and an error control component 220) that are coupled with the one or more memory devices 245, which may enable the system 200 to support dynamic adaptation of error control operations.

A memory system 210 may be configured to support error control techniques (e.g., such as an ECC scheme, EDC scheme, cyclic redundancy check (CRC) parity) that improves data integrity by detecting and correcting data bit errors (e.g., bit flips). For instance, data bit errors may occur during transmission (e.g., between the host system 205 and the memory system 210, between internal components), during data storage, and other stages of memory operation. As such, error control techniques may mitigate data corruption, data loss, and other adverse effects at the system 200 (e.g., at the memory system 210 prior to communicating the data with the host system 205). In some cases, some memory system 210 may implement a relatively static error control technique in which the error control operations (e.g., including detection and correction) may be predefined and/or unchangeable once implemented at the memory system 210. That is, a memory system 210 may support an error control scheme based on an initial configuration (e.g., chosen during manufacture, based on hard-coding or a fixed hardware implementation), thus the memory system 210 may support a fixed level of error control (e.g., a single error control scheme). In some examples, the memory system 210 may be configured with a single error control scheme. In such examples, the techniques described herein also support selecting error control scheme from a plurality of possible error control schemes as part of an initial configuration of the memory system. In some cases, the selected error control scheme may be reconfigurable after the initial configuration of the memory system. In some cases, the selected error control scheme may not be reconfigurable. However, the initial configuration may still have been selected from a plurality of possible error control schemes.

In some cases, error control implementations, such as relatively static error control techniques, may lack a flexibility to adapt to varying operating conditions. For instance, some operating conditions may change over time, such as error characteristics (e.g., a quantity of errors detected and corrected memory system 210), system health (e.g., wear out, or other health-based metric), environmental conditions (e.g., thermal metric, workload metrics), and host interface parameters (e.g., a requested error protection level, performance expectations of the memory system 210). Thus, error control techniques that are unable to adapt to changing conditions may result in reduced performance, higher error rates, increased data loss, and other effects over a life of the system 200.

In accordance with various techniques described herein, the system 200 may include an error control component 215 (e.g., an ECC module, a buffer, an error control chip, an error control component), which may support adaptable schemes (e.g., implementations, techniques, methods) for error control (e.g., error detection and correction). For example, the memory system 210 may support (e.g., may be configured to implement) multiple (e.g., one or more) error control schemes (e.g., based on the inclusion of the error control component 215). The error control component 215 may be coupled with one or more memory devices 245 (e.g., memory device 145, DRAM devices, memory arrays, memory chips) and may be configured to perform error control operations for data associated with (e.g., stored at, communicated with) the one or more memory devices 245. Some non-limiting examples of error control schemes may include various ECC algorithms (e.g., ECC using single error correcting (SEC) codes, or SEC and double error detecting (SECDED) codes), Reed Solomon error correction, redundant array of independent disks data recovery (RAIDDR), full single device data correction (SDDC) capable algorithms, among other examples. Each error control scheme may be further associated with one or more error control parameters such as a bit quantity, a parity-check matrix (e.g., an H matrix), an error detection type (e.g., adjacent errors, random errors, bit flip errors), and other parameters.

In some examples, the memory system 210 (e.g., the error control component 215) may be configured to detect (e.g., monitor, measure, sense, determine, identify) one or more error control trigger conditions (e.g., operating conditions, signals, events). The error control trigger conditions may include satisfying one or more thresholds (e.g., a threshold duration of lifetime, a health metric threshold, a threshold quantity of errors received by the error control component 215, a performance metric threshold, a threshold quantity of operations performed by the memory system 210, or some other threshold), switching a mode of operation (e.g., between a performance mode and a reliability mode), communicating a signal or command from the host system 205 (e.g., a signal from the host system 205 that indicates a set of error control parameters that are to be met by the memory system 210), or some other operation condition of the memory system 210. Based on detecting one or more trigger conditions, the memory system 210 may select an error control scheme from a set of multiple schemes that are configured to be implemented by the error control component 215 (e.g., and the error control component 220, and one or more additional error control components (not shown)).

As a non-limiting example, the memory system 210 may be configured to monitor a duration that tracks a lifetime of the memory system 210 (e.g., or one or more components thereof). After satisfying a threshold duration (e.g., a quantity of program/erase cycles, a duration of time), the error control component 215 may determine to select a new error control scheme (e.g., to compensate for the aging components of the memory system 210). As another example, the memory system 210 may be configured to monitor one or more health metrics (e.g., using a health monitoring component that interfaces with the error control component 215). After satisfying health threshold, the error control component 215 may determine to select a new error control scheme (e.g., which may increase an allotted duration to perform the error control operations).

The various error control schemes may be implemented by one error control component (e.g., the error control component 215) or may be implemented by multiple error control components (e.g., including more error control components than shown). For example, a single error control component (e.g., the error control component 215) may support multiple schemes, and the desired scheme may be selected for use by the single error control component. Such selection may be based on programming one or more mode registers (e.g., or some other programmable bank) of the memory system 210. In some examples, the mode registers may be programmed based on a determination by the memory system 210 (e.g., internal detection of a trigger condition), based on one or more commands (e.g., a mode register command) received from the host system 205, based on other signaling from the host system 205 (e.g., an error control configuration signal, a signal that indicates one or more error control parameters that are to be implemented by the memory system 210), or a combination thereof. In some examples, the error control component 215 may transmit an indication of a quantity of received errors (e.g., to a memory system controller 140) and the memory system 210 may select a new scheme based on the indication. In some examples, the selection of the error control scheme may be based on fuse programming.

Additionally, or alternatively, the memory system 210 may include two or more error control components, which may be coupled with each other and coupled with the one or more memory devices 245. The multiple error control components may each support (e.g., be hard-coded with, be programmed by one or more mode registers) one or more respective error control schemes. For example, the memory system 210 may also include the error control component 215 and an error control component 220 (e.g., a second ECC module, a second error control chip) that is coupled with the one or more memory devices 245 (e.g., and with the error control component 220). In such examples, the error control component 215 may support a first error control scheme and the error control component 220 may support a second error control scheme that is different than the first error control scheme. In such examples, each of the multiple error control components may be configured to utilize a particular scheme based on one or more mode registers, one or more commands, host signaling, or a combination thereof. Moreover, the memory system 210 may select whether to use the error control component 215, the error control component 220, or both.

In some examples, the memory system 210 may use both the error control component 215 and the error control component 220 to perform an error control operation. For example, the memory system 210 may divide a set of data bits into multiple portions and may use the error control component 215 to detect and correct errors for a first portion of the data and use the error control component 220 to detect and correct errors for a second portion of the data. Thus, based on detecting a trigger condition, the memory system 210 may select the error control component 215, the error control component 220, or both to perform error control operations to protect the data of the memory devices 245.

In some examples, the memory system 210 (e.g., the error control component 215) may communicate information associated with one or more error control operations with the host system 205 and/or with the one or more memory devices 245. For example, the memory system 210 may transmit an indication of its error control capabilities (e.g., supported error control schemes, a quantity of detected and/or corrected errors) to the host system 205. Additionally, or alternatively, the indication may include an indication of a quality of service (QoS) level associated with the memory system 210 (e.g., a qualitative indication such as low, medium, high). Based on the indication, the host system 205 may request a particular error control scheme (e.g., by selecting an error control scheme, by transmitting a set of error control parameters or metrics that are to be met by the memory system 210) or may adjust its communications with the memory system 210 (e.g., by transmitting more access commands or fewer access commands). In some examples, the memory system 210 may transmit an indication of whether error correction was performed for a set of data bits. For example, the memory system 210 may indicate that the error control component 215 did not perform error correction operations on the set of data (e.g., the set of data is “clean” data) or may indicate that error correction operations were performed on the set of data (e.g., indicate that at least one bit error was detected and corrected).

In some examples, the error control component 215 (e.g., and/or the error control component 220) may transmit one or more signals to the one or more memory devices 245. The signals may include an indication that the error control component 215 has satisfied a threshold quantity of correctible errors. Accordingly, the error control component 215 may indicate that that the one or more memory devices 245 is to use additional bits in order to support the error control operations, or may indicate that the error control component 215 is to forward the data to the one or more memory devices 245 without performing error control operations.

Accordingly, by utilizing one or more techniques described herein, the memory system 210 may support various error control schemes, which may be implemented in a configurable manner across one or more error control components of the memory system 210. Such techniques may enable a memory system 210 to dynamically select an error control scheme based on real-time operating conditions to use for error control operations (e.g., based on one or more error control trigger conditions). Additionally, or alternatively, the various error control schemes may be implemented by the memory system 210 based on selectable options (e.g., programmable banks, mode registers) of the one or more error control components. Thus, the system 200 may be enabled to balance a trade-off between error correction strength and system performance, resulting in improved robustness of data integrity management, improved performance over the life of the system 200, and improved efficiency in changing environments, among other benefits

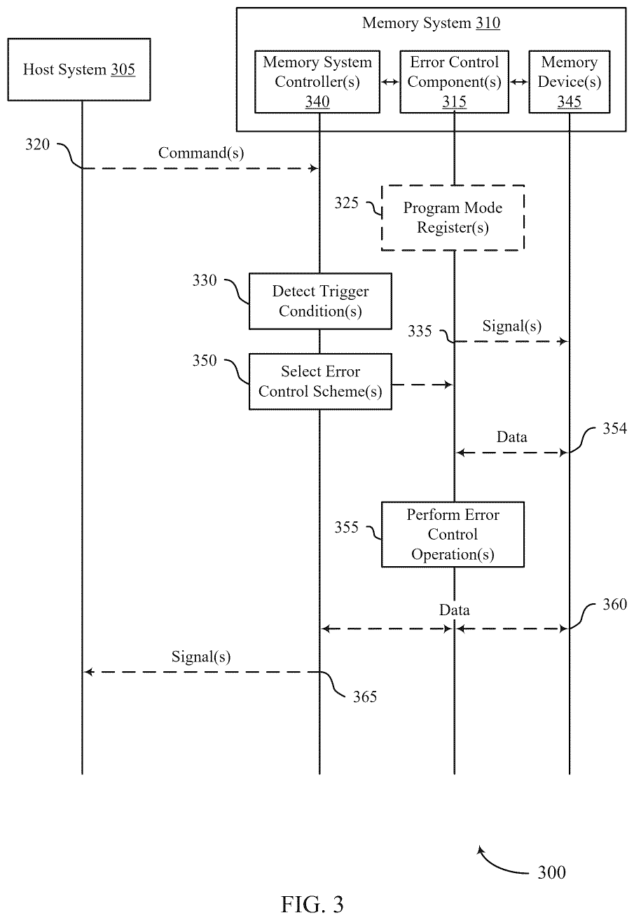

FIG. 3 shows an example of a process flow 300 that supports dynamic error correction schemes for memory systems in accordance with examples as disclosed herein. The process flow 300 may implement or be implemented to realize aspects of the system 100 (e.g., a host system 105 or subcomponent thereof, a memory system 110 or subcomponents thereof) or the system 200. For example, the process flow 300 illustrates communication between a host system 305 and a memory system 310 that includes one or more memory system controllers 340, one or more error control components 315, and one or more memory devices 345, which may be examples of corresponding devices described herein (e.g., and may be communicatively coupled with each other), including with reference to FIGS. 1 and 2 (e.g., host system 105, host system 205, memory system 110, memory system 210, memory system controller 140, error control component 215, error control component 220, memory devices 145, memory devices 245, among other examples).

Alternative examples of the following may be implemented. For example, some steps may be performed in a different order than described or may not be performed at all. In some implementations, steps may include additional features not mentioned below, or further steps may be added. Further, although examples are shown with particular components (e.g., memory system controllers 340, error control components 315, memory devices 345) performing the operations of the process flow 300, some aspects of some operations may also be performed by other devices or components. For example, the one or more error control components 315 may, additionally, or alternatively, be configured to receive commands from the host system 305, detect trigger conditions, select error control schemes, transmit signals to the host system 305 or perform other operation of the process flow 300.

At 320, one or more commands may be received by the memory system 310. For example, the memory system controller 340 may receive, from a host system 305, a command to read data stored at the one or more memory devices 345. Additionally, or alternatively, the memory system 310 may receive one or more commands that configure one or more error control parameters (e.g., a level of error correction, a quantity of correctable errors, a duration or delay associated with performing error control operations) associated with one or more error control schemes that are supported by the memory system 310 (e.g., by the one or more one or more error control components 315). For example, the commands may include an indication of performance metrics (e.g., a delay, a reliability metric) that are expected to be satisfied by the memory system 310. Accordingly, the memory system 310 may configure its error control schemes in order to satisfy the requested performance metrics.

At 325, one or more registers (e.g., mode registers, programmable banks) may be programmed by the memory system 310. For example, the one or more error control components 315 may program one or more mode registers of the memory system 310 based on receiving the one or more commands to configure the one or more error control parameters. In some examples, each of the one or more error control components may program a respective set of mode register to configure respective sets of error control parameters (e.g., for different error control schemes).

At 330, one or more trigger conditions (e.g., error control trigger conditions) may be detected by the memory system 310. For example, the memory system controller 340 (e.g., or the error control component 315) may detect one or more trigger conditions for adjusting an error control operation of the memory system 310. In some examples, the one or more trigger conditions may include a threshold quantity of errors detected and/or corrected by the error control component 315 being satisfied. Additionally, or alternatively, the trigger condition may include a threshold duration associated with a lifetime (e.g., a quantity of program/erase cycles, a duration of time) of the memory system 310 being satisfied.

Additionally, or alternatively, the trigger condition may include a threshold health metric (e.g., a level or wear-out, a measure of hardware performance) of the memory system 310 being satisfied. Additionally, or alternatively, the trigger condition may include a threshold thermal metric (e.g., a temperature threshold) of the memory system 310 being satisfied. Additionally, or alternatively, the trigger condition may include a threshold performance metric associated with accessing the one or more memory devices 345 being satisfied (e.g., based on a mode that is utilized by the memory system 310 such as a performance mode or a reliability mode).

At 335, one or more signals may be transmitted by the memory system 310. For example, the one or more error control component 315 may transmit a signal to the one or more memory devices 345 based on a detection of the one or more trigger conditions. In some examples, the signal may include information associated with a capability of the memory system 310 to perform the one or more error control operations. For example, the information may indicate whether the error control component 315 has satisfied a threshold quantity of detected and/or corrected errors and whether the error control component is able to continue performing error control operations. In some examples, the information may indicate that the error control component is unable to correct errors and that the data transmitted to the memory devices 345 may contain one or more errors. Accordingly, the memory devices 345, in some examples, may be configured to adjust data communications (e.g., data transfer rates) with the error control component 315.

At 350, an error control scheme may be selected from a set of multiple error control schemes supported by the memory system 310. For example, the memory system controller 340 may select an error control scheme from a set of multiple error control schemes. In some examples, each of the error control schemes may be configured to be implemented by one or more of the error control components 315. In some examples, selecting the error control scheme may be based on detecting the one or more trigger conditions, based on programming the one or more mode registers, based on signaling from the host system 305, or a combination thereof. Each of the error control schemes may be associated with respective parity-check matrixes (e.g., that are different from each other). Additionally, or alternatively, the error control schemes may be associated with, an ECC algorithm, Reed Solomon error correction, RAIDDR techniques, full SDDC-capable algorithms, and other examples of error control techniques.

Additionally, or alternatively, the memory system 310 may include multiple error control components 315. For example, the memory system may further include a second error control component that is coupled with the one or more memory devices 345. The second error control component may implement a same set of error control schemes as one or more other error control components 315 or each error control component 315 may implement different error control schemes. Accordingly, the memory system controller 340 may further select a second error control scheme (e.g., from the set of multiple error control schemes) based on detecting the one or more trigger conditions, which may be utilized by the second error control component. In some examples, the memory system controller 340 may indicate the selected scheme to the error control components 315.

At 354, data may be communicated between the error control component 315 and the one or more memory devices 345. For example, the error control component 315 may read the data from the one or more memory devices 345 to detect and/or correct one or more errors associated with the data store at the one or more memory devices 345.

At 355, one or more error control operations (e.g., error detection and error correction) may be performed by the memory system 310. For example, the one or more error control components 315 may perform one or more error control operations using the selected error control scheme. The error control operations may protect data stored at the one or more memory devices 345. In some examples, a first error control component 315 may perform a first set of error control operations using a first scheme, and a second error control component 315 may perform a second set of error control operations using a second scheme. Additionally, or alternatively, the first error control component 315 may perform error control operations for a first portion of data received from the one or more memory devices 345 and the second error control component 315 may perform the error control operations for a second portion of the received data. In some examples, the one or more error control component 315 may be included in one or more first chips of the memory system 310, and the one or more memory devices 345 may include in one or more second chips of the memory system 310 that are different than the first chips.

At 360, data may be communicated with the one or more memory devices 345 and/or the memory system controller 340. For example, the one or more memory devices 345 may include at least a first memory device 345 and a second memory device 345. In some examples, the error control component 315 may communicate first data (e.g., corrected data) with the first memory device 345 in accordance with (e.g., after, in response to) performing the one or more error control operations. Additionally, or alternatively, the error control component 315 may communicate second data with the second memory device in accordance with performing the one or more error control operations. Additionally, or alternatively, the error control component 315 may communicate data (e.g., transmit corrected data) with the memory system controller 340.

At 365, one or more signals may be transmitted to the host system 305. For example, the memory system controller 340 may transmit a signal to the host system 305 in response to the command received from the host system 305 (e.g., a read command, a write command). In some examples, the signal may include data that corresponds to the received command as well as an indication of whether the data is associated with one or more corrected errors (e.g., a syndrome indication, one or more syndrome bits). For example, the signal may indicate that the data includes one or more corrected errors, one or more uncorrected errors, or no errors. In some examples, the signal may be transmitted based on performing the one or more error control operations. For example, the signal may include an indication of a quality of service level (e.g., low, medium, high) associated with performing of the one or more error control operations. Accordingly, the host system 305 may be able to adjust its operations (e.g., issuance of read commands and/or write commands) based on receiving the one or more signals.

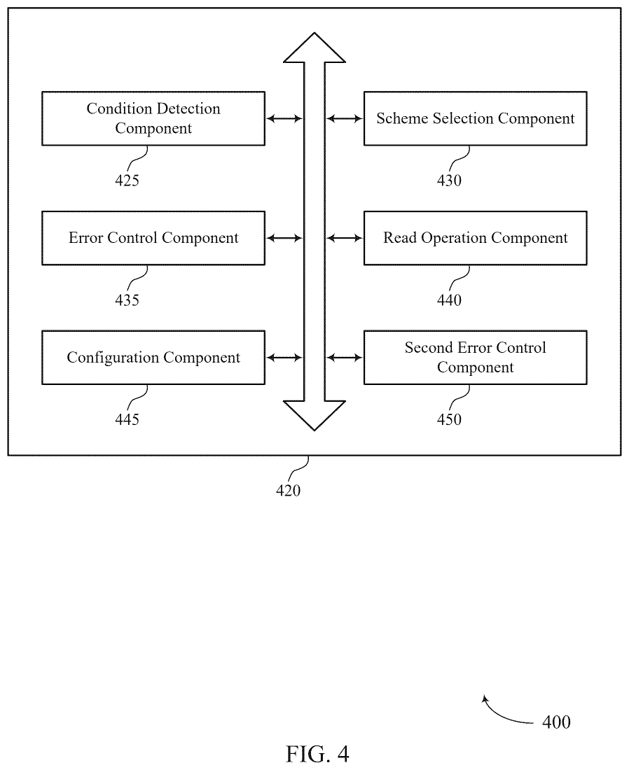

FIG. 4 shows a block diagram 400 of a memory system 420 that supports dynamic error correction schemes for memory systems in accordance with examples as disclosed herein. The memory system 420 may be an example of aspects of a memory system as described with reference to FIGS. 1 through 3. The memory system 420, or various components thereof, may be an example of means for performing various aspects of dynamic error correction schemes for memory systems as described herein. For example, the memory system 420 may include a condition detection component 425, a scheme selection component 430, an error control component 435, a read operation component 440, a configuration component 445, a second error control component 450, or any combination thereof. Each of these components, or components of subcomponents thereof (e.g., one or more processors, one or more memories), may communicate, directly or indirectly, with one another (e.g., via one or more buses).

The condition detection component 425 may be configured as or otherwise support a means for detecting one or more trigger conditions for adjusting an error control operation of the memory system, the memory system including an error control component and one or more memory devices coupled with the error control component. The scheme selection component 430 may be configured as or otherwise support a means for selecting an error control scheme from a plurality of error control schemes configured to be implemented by the error control component based at least in part on detecting the one or more trigger conditions. The error control component 435 may be configured as or otherwise support a means for performing, by the error control component using the selected error control scheme, one or more error control operations to protect data stored at the one or more memory devices.

In some examples, the one or more memory devices include at least a first memory device and a second memory device, and the error control component 435 may be configured as or otherwise support a means for communicating, by the error control component, first data with the first memory device in accordance with performing the one or more error control operations. In some examples, the one or more memory devices include at least a first memory device and a second memory device, and the error control component 435 may be configured as or otherwise support a means for communicating, by the error control component, second data with the second memory device in accordance with performing the one or more error control operations.

In some examples, the one or more trigger conditions includes a threshold quantity of errors detected and corrected by the error control component being satisfied, a threshold duration associated with a lifetime of the memory system being satisfied, a threshold health metric of the memory system being satisfied, a threshold thermal metric of the memory system being satisfied, a threshold performance metric associated with accessing the one or more memory devices being satisfied, or any combination thereof.

In some examples, the error control component 435 may be configured as or otherwise support a means for transmitting, by the error control component, a signal to the one or more memory devices based at least in part on detecting the one or more trigger conditions, the signal including information associated with a capability of the memory system to perform the one or more error control operations.

In some examples, the read operation component 440 may be configured as or otherwise support a means for receiving, from a host system, a command to read data stored at the one or more memory devices. In some examples, the read operation component 440 may be configured as or otherwise support a means for reading the data from the one or more memory devices in accordance with performing the one or more error control operations to correct one or more errors associated with the data. In some examples, the error control component 435 may be configured as or otherwise support a means for transmitting, by the error control component to the host system, a signal in response to the command, the signal including the data corresponding to the command and an indication of whether the data is associated with one or more corrected errors.

In some examples, the error control component 435 may be configured as or otherwise support a means for transmitting, by the error control component, a signal to a host system based at least in part on performing the one or more error control operations, the signal including an indication of a quality of service level associated with performing of the one or more error control operations.

In some examples, the configuration component 445 may be configured as or otherwise support a means for receiving, from a host system, one or more commands that configure one or more error control parameters associated with the plurality of error control schemes. In some examples, the error control component 435 may be configured as or otherwise support a means for programming, by the error control component, one or more mode registers of the memory system based at least in part on receiving the one or more commands to configure the one or more error control parameters, where selecting the error control scheme is based at least in part on programming the one or more mode registers.

In some examples, the memory system includes a second error control component coupled with the one or more memory devices and that implements the plurality of error control schemes, and the second error control component 450 may be configured as or otherwise support a means for selecting a second error control scheme from the plurality of error control schemes based at least in part on detecting the one or more trigger conditions. In some examples, the memory system includes a second error control component coupled with the one or more memory devices and that implements the plurality of error control schemes, and the second error control component 450 may be configured as or otherwise support a means for performing, by the second error control component using the second error control scheme, one or more second error control operations to protect the data stored at the one or more memory devices.

In some examples, the error control scheme is associated with a first parity-check matrix and the second error control scheme is associated with a second parity-check matrix different than the first parity-check matrix.

In some examples, the error control component is included in a first chip of the memory system and the one or more memory devices are included in one or more second chips of the memory system that are different than the first chip.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

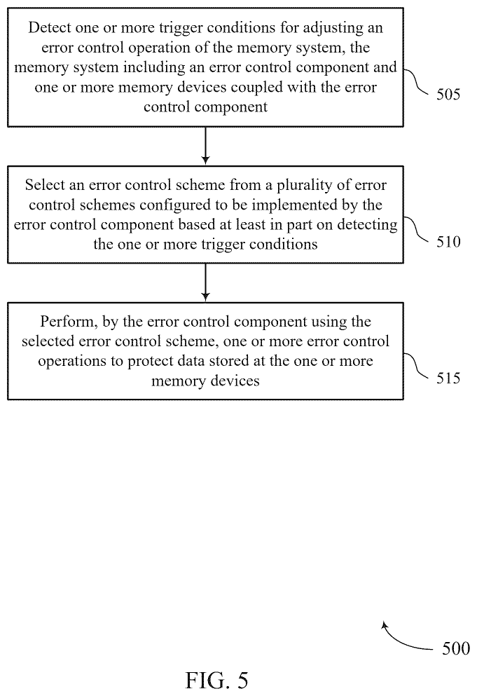

FIG. 5 shows a flowchart illustrating a method 500 that supports dynamic error correction schemes for memory systems in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include detecting one or more trigger conditions for adjusting an error control operation of the memory system, the memory system including an error control component and one or more memory devices coupled with the error control component. In some examples, aspects of the operations of 505 may be performed by a condition detection component 425 as described with reference to FIG. 4.

At 510, the method may include selecting an error control scheme from a plurality of error control schemes configured to be implemented by the error control component based at least in part on detecting the one or more trigger conditions. In some examples, aspects of the operations of 510 may be performed by a scheme selection component 430 as described with reference to FIG. 4.

At 515, the method may include performing, by the error control component using the selected error control scheme, one or more error control operations to protect data stored at the one or more memory devices. In some examples, aspects of the operations of 515 may be performed by an error control component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for detecting one or more trigger conditions for adjusting an error control operation of the memory system, the memory system including an error control component and one or more memory devices coupled with the error control component; selecting an error control scheme from a plurality of error control schemes configured to be implemented by the error control component based at least in part on detecting the one or more trigger conditions; and performing, by the error control component using the selected error control scheme, one or more error control operations to protect data stored at the one or more memory devices.
Aspect 2: The method, apparatus, or non-transitory computer-readable medium of aspect 1, where the one or more memory devices include at least a first memory device and a second memory device and the method, apparatuses, and non-transitory computer-readable medium further includes operations, features, circuitry, logic, means, or instructions, or any combination thereof for communicating, by the error control component, first data with the first memory device in accordance with performing the one or more error control operations and communicating, by the error control component, second data with the second memory device in accordance with performing the one or more error control operations.
Aspect 3: The method, apparatus, or non-transitory computer-readable medium of any of aspects 1 through 2, where the one or more trigger conditions includes a threshold quantity of errors detected and corrected by the error control component being satisfied, a threshold duration associated with a lifetime of the memory system being satisfied, a threshold health metric of the memory system being satisfied, a threshold thermal metric of the memory system being satisfied, a threshold performance metric associated with accessing the one or more memory devices being satisfied, or any combination thereof.
Aspect 4: The method, apparatus, or non-transitory computer-readable medium of any of aspects 1 through 3, further including operations, features, circuitry, logic, means, or instructions, or any combination thereof for transmitting, by the error control component, a signal to the one or more memory devices based at least in part on detecting the one or more trigger conditions, the signal including information associated with a capability of the memory system to perform the one or more error control operations.
Aspect 5: The method, apparatus, or non-transitory computer-readable medium of any of aspects 1 through 4, further including operations, features, circuitry, logic, means, or instructions, or any combination thereof for receiving, from a host system, a command to read data stored at the one or more memory devices; reading the data from the one or more memory devices in accordance with performing the one or more error control operations to correct one or more errors associated with the data; and transmitting, by the error control component to the host system, a signal in response to the command, the signal including the data corresponding to the command and an indication of whether the data is associated with one or more corrected errors.
Aspect 6: The method, apparatus, or non-transitory computer-readable medium of any of aspects 1 through 5, further including operations, features, circuitry, logic, means, or instructions, or any combination thereof for transmitting, by the error control component, a signal to a host system based at least in part on performing the one or more error control operations, the signal including an indication of a quality of service level associated with performing of the one or more error control operations.
Aspect 7: The method, apparatus, or non-transitory computer-readable medium of any of aspects 1 through 6, further including operations, features, circuitry, logic, means, or instructions, or any combination thereof for receiving, from a host system, one or more commands that configure one or more error control parameters associated with the plurality of error control schemes and programming, by the error control component, one or more mode registers of the memory system based at least in part on receiving the one or more commands to configure the one or more error control parameters, where selecting the error control scheme is based at least in part on programming the one or more mode registers.
Aspect 8: The method, apparatus, or non-transitory computer-readable medium of any of aspects 1 through 7, where the memory system includes a second error control component coupled with the one or more memory devices and that implements the plurality of error control schemes and the method, apparatuses, and non-transitory computer-readable medium further includes operations, features, circuitry, logic, means, or instructions, or any combination thereof for selecting a second error control scheme from the plurality of error control schemes based at least in part on detecting the one or more trigger conditions and performing, by the second error control component using the second error control scheme, one or more second error control operations to protect the data stored at the one or more memory devices.
Aspect 9: The method, apparatus, or non-transitory computer-readable medium of aspect 8, where the error control scheme is associated with a first parity-check matrix and the second error control scheme is associated with a second parity-check matrix different than the first parity-check matrix.
Aspect 10: The method, apparatus, or non-transitory computer-readable medium of any of aspects 1 through 9, where the error control component is included in a first chip of the memory system and the one or more memory devices are included in one or more second chips of the memory system that are different than the first chip.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
an error control component;
one or more memory devices coupled with the error control component; and
processing circuitry coupled with the one or more memory devices and configured to cause the memory system to:
detect one or more trigger conditions for adjusting an error control operation of the memory system;
select an error control scheme from a plurality of error control schemes configured to be implemented by the error control component based at least in part on detecting the one or more trigger conditions; and
perform, by the error control component using the selected error control scheme, one or more error control operations to protect data stored at the one or more memory devices.

2. The memory system of claim 1, wherein the one or more memory devices comprise at least a first memory device and a second memory device, and the processing circuitry is further configured to cause the memory system to:
communicate, by the error control component, first data with the first memory device in accordance with performing the one or more error control operations; and
communicate, by the error control component, second data with the second memory device in accordance with performing the one or more error control operations.

3. The memory system of claim 1, wherein the one or more trigger conditions comprises a threshold quantity of errors detected and corrected by the error control component being satisfied, a threshold duration associated with a lifetime of the memory system being satisfied, a threshold health metric of the memory system being satisfied, a threshold thermal metric of the memory system being satisfied, a threshold performance metric associated with accessing the one or more memory devices being satisfied, or any combination thereof.

4. The memory system of claim 1, wherein the processing circuitry is further configured to cause the memory system to:
transmit, by the error control component, a signal to the one or more memory devices based at least in part on detecting the one or more trigger conditions, the signal comprising information associated with a capability of the memory system to perform the one or more error control operations.

5. The memory system of claim 1, wherein the processing circuitry is further configured to cause the memory system to:
receive, from a host system, a command to read data stored at the one or more memory devices;
read the data from the one or more memory devices in accordance with performing the one or more error control operations to correct one or more errors associated with the data; and
transmit, by the error control component to the host system, a signal in response to the command, the signal comprising the data corresponding to the command and an indication of whether the data is associated with one or more corrected errors.

6. The memory system of claim 1, wherein the processing circuitry is further configured to cause the memory system to:
transmit, by the error control component, a signal to a host system based at least in part on performing the one or more error control operations, the signal comprising an indication of a quality of service level associated with performing of the one or more error control operations.

7. The memory system of claim 1, wherein the processing circuitry is further configured to cause the memory system to:
receive, from a host system, one or more commands that configure one or more error control parameters associated with the plurality of error control schemes; and
programming, by the error control component, one or more mode registers of the memory system based at least in part on receiving the one or more commands to configure the one or more error control parameters, wherein selecting the error control scheme is based at least in part on programming the one or more mode registers.

8. The memory system of claim 1, wherein the memory system comprises a second error control component coupled with the one or more memory devices and that implements the plurality of error control schemes, and the processing circuitry is further configured to cause the memory system to:
select a second error control scheme from the plurality of error control schemes based at least in part on detecting the one or more trigger conditions; and
perform, by the second error control component using the second error control scheme, one or more second error control operations to protect the data stored at the one or more memory devices.

9. The memory system of claim 8, wherein the error control scheme is associated with a first parity-check matrix and the second error control scheme is associated with a second parity-check matrix different than the first parity-check matrix.

10. The memory system of claim 1, wherein the error control component is included in a first chip of the memory system and the one or more memory devices are included in one or more second chips of the memory system that are different than the first chip.

11. A method by a memory system, comprising:
detecting one or more trigger conditions for adjusting an error control operation of the memory system, the memory system comprising an error control component and one or more memory devices coupled with the error control component;
selecting an error control scheme from a plurality of error control schemes configured to be implemented by the error control component based at least in part on detecting the one or more trigger conditions; and
performing, by the error control component using the selected error control scheme, one or more error control operations to protect data stored at the one or more memory devices.

12. The method of claim 11, wherein the one or more memory devices comprise at least a first memory device and a second memory device, the method further comprising:
communicating, by the error control component, first data with the first memory device in accordance with performing the one or more error control operations; and
communicating, by the error control component, second data with the second memory device in accordance with performing the one or more error control operations.

13. The method of claim 11, wherein the one or more trigger conditions comprises a threshold quantity of errors detected and corrected by the error control component being satisfied, a threshold duration associated with a lifetime of the memory system being satisfied, a threshold health metric of the memory system being satisfied, a threshold thermal metric of the memory system being satisfied, a threshold performance metric associated with accessing the one or more memory devices being satisfied, or any combination thereof.

14. The method of claim 11, further comprising:
transmitting, by the error control component, a signal to the one or more memory devices based at least in part on detecting the one or more trigger conditions, the signal comprising information associated with a capability of the memory system to perform the one or more error control operations.

15. The method of claim 11, further comprising:
receiving, from a host system, a command to read data stored at the one or more memory devices;
reading the data from the one or more memory devices in accordance with performing the one or more error control operations to correct one or more errors associated with the data; and
transmitting, by the error control component to the host system, a signal in response to the command, the signal comprising the data corresponding to the command and an indication of whether the data is associated with one or more corrected errors.

16. The method of claim 11, further comprising:
transmitting, by the error control component, a signal to a host system based at least in part on performing the one or more error control operations, the signal comprising an indication of a quality of service level associated with performing of the one or more error control operations.

17. The method of claim 11, further comprising:
receiving, from a host system, one or more commands that configure one or more error control parameters associated with the plurality of error control schemes; and
programming, by the error control component, one or more mode registers of the memory system based at least in part on receiving the one or more commands to configure the one or more error control parameters, wherein selecting the error control scheme is based at least in part on programming the one or more mode registers.

18. The method of claim 11, wherein the memory system comprises a second error control component coupled with the one or more memory devices and that implements the plurality of error control schemes, the method further comprising:
selecting a second error control scheme from the plurality of error control schemes based at least in part on detecting the one or more trigger conditions; and
performing, by the second error control component using the second error control scheme, one or more second error control operations to protect the data stored at the one or more memory devices.

19. The method of claim 18, wherein the error control scheme is associated with a first parity-check matrix and the second error control scheme is associated with a second parity-check matrix different than the first parity-check matrix.

20. The method of claim 11, wherein the error control component is included in a first chip of the memory system and the one or more memory devices are included in one or more second chips of the memory system that are different than the first chip.

21. A non-transitory computer-readable medium storing code, the code comprising instructions executable by one or more processors to:
detect one or more trigger conditions for adjusting an error control operation of a memory system, the memory system comprising an error control component and one or more memory devices coupled with the error control component;
select an error control scheme from a plurality of error control schemes configured to be implemented by the error control component based at least in part on detecting the one or more trigger conditions; and
perform, by the error control component using the selected error control scheme, one or more error control operations to protect data stored at the one or more memory devices.

22. The non-transitory computer-readable medium of claim 21, wherein the one or more memory devices comprise at least a first memory device and a second memory device, and the instructions are further executable by the one or more processors to:
communicate, by the error control component, first data with the first memory device in accordance with performing the one or more error control operations; and
communicate, by the error control component, second data with the second memory device in accordance with performing the one or more error control operations.

23. The non-transitory computer-readable medium of claim 21, wherein the one or more trigger conditions comprises a threshold quantity of errors detected and corrected by the error control component being satisfied, a threshold duration associated with a lifetime of the memory system being satisfied, a threshold health metric of the memory system being satisfied, a threshold thermal metric of the memory system being satisfied, a threshold performance metric associated with accessing the one or more memory devices being satisfied, or any combination thereof.

24. The non-transitory computer-readable medium of claim 21, wherein the instructions are further executable by the one or more processors to:
transmit, by the error control component, a signal to the one or more memory devices based at least in part on detecting the one or more trigger conditions, the signal comprising information associated with a capability of the memory system to perform the one or more error control operations.

25. The non-transitory computer-readable medium of claim 21, wherein the instructions are further executable by the one or more processors to:
receive, from a host system, a command to read data stored at the one or more memory devices;
read the data from the one or more memory devices in accordance with performing the one or more error control operations to correct one or more errors associated with the data; and
transmit, by the error control component to the host system, a signal in response to the command, the signal comprising the data corresponding to the command and an indication of whether the data is associated with one or more corrected errors.
